(19) United States
(12) Patent Application Publication
(10) Pub. No.: US 2019/0197711 A1
(43) Pub. Date: Jun. 27, 2019

(54) METHOD AND SYSTEM FOR RECORDING SPATIAL INFORMATION

(71) Applicant: RETURN TO SCENE LIMITED, Barrow-In-Furness (GB)

(72) Inventor: Martin MACRAE, Barrow-In-Furness (GB)

(21) Appl. No.: 16/330,512

(22) PCT Filed: Sep. 5, 2017
(86) PCT No.: PCT/GB2017/052577

§ 371 Date: Mar. 5, 2019

(30) Foreign Application Priority Data
Sep. 5, 2016 (GB) 1615052.6

(51) Int. Cl. G06T 7/50; G06T 15/40; G06T 7/70; G06T 19/00; G06T 17/20; G06F 17/50

(52) U.S. Cl. CPC G06T 7/50; G06T 15/40; G06T 7/70; G06T 19/00; G06T 2219/004; G06F 17/50; G06T 2207/10028; G06T 2207/30244; G06T 17/20

(57) ABSTRACT

Existing methods and systems for recording of complex spatial information, which can be used to record, for example, the structure and plant and machine of oil rigs, generally require storage of large amounts of data. There is a need for systems and methods which can combine photographic images with 3D spatial locations and which can be operated using readily available computing equipment such as laptops and tablets. There is provided a method for recording spatial information, which comprises forming a point cloud representing objects within a given volume of space, obtaining at least one image from at least one given location within the given volume, determining those points in the point cloud which are visible from the given location and discarding points in the point cloud which are not visible from the given location, using the remaining point cloud data to determine the distance from the given location to locations on the surface of objects represented in the image and determining three dimensional coordinates of said surface locations.

### FIELD OF THE INVENTION

This invention relates to a method and system for recording spatial information in a manner which facilitates the display of the space recorded and associated data. This invention also relates to a data processing and display system.

### BACKGROUND TO THE INVENTION

Systems are known which record complex spatial information, such as the structure and plant and machinery of an oil rig. One example is the ‘Visual Asset Management’ (VAM) system of R2S Limited; see www.r2s.com. This makes use of a series of 360° digital camera images to generate a display which the user can manipulate in a walk-through fashion. The VAM system also allows other data such as text files to be associated with given locations within the image.

Existing systems, however, have a number of limitations. Where the display is based on recorded 360° images, the spatial information is essentially in the form of a directional vector from the camera location, with no depth information. Thus, each pixel in the image is not defined in three-dimensional (3D) space, and this makes it difficult or impossible to relate points in an image from one camera with those from another camera.

It is also known to record spatial information in the form of a point cloud obtained by laser scanning or photogrammetry. This gives points which are defined in 3D space, but requires the storage of large amounts of data.

If one were to attempt to devise a system which simply combined 360° images with a point cloud, the resulting mass of data would require the use of a supercomputer and be impracticable for everyday commercial use.

There is therefore a need for a system and method which can combine photographic images with 3D spatial locations and which can be operated using readily available computing equipment such as laptops and tablets.

The present inventors have appreciated the shortcomings in such known systems.

### SUMMARY OF THE INVENTION

According to first aspect of the present invention there is provided a method for recording spatial information, comprising:
forming a point cloud representing objects within a given volume of space;
obtaining at least one image from at least one given location within the given volume;
determining those points in the point cloud which are visible from the given location and discarding points in the point cloud which are not visible from the given location;
using the remaining point cloud data to determine the distance from the given location to locations on the surface of objects represented in the image; and
determining three dimensional coordinates of said surface locations.

The point may include points which are defined in three-dimensional space.

The point cloud may be point cloud data.

The point cloud may contain an unordered collection of vertices in three-dimensional space which represents at least a portion of the area/volume captured.

The point cloud may be formed from a laser scan, photogrammetry software, or the like.

The step of obtaining at least one image from at least one given location within the given volume may include obtaining a photograph from one or more cameras in equiangular projection.

The photograph may be tiled. The photograph may undergo a tiling process. The tiling process may include tiling at a number of levels, each level containing an increasing number of tiles.

The photograph may be a spherical photograph.

The step of obtaining at least one image from at least one given location within the given volume may include obtaining at least one set of camera positions within the point cloud which describe the location of the at least one image.

The step of determining the points in the point cloud which are visible from the given location and discarding the points in the point cloud which are not visible from the given location may include the step of evaluating each vertex in the point cloud data on the basis of pan and tilt angles between the camera position and the vertex and, where two point cloud vertices share the same pan and tilt angles, discarding the one which is more distant from the camera position.

The method may include the step of culling the vertices further. This may include discarding every second, third or fourth vertex, and so on. This may include discarding every n^{th} vertex. This may additionally or alternatively include comparing adjacent vertices and discarding vertices if there is no significant difference in two or more dimensions. This step of culling the vertices may be plane detection.

The method may include the step of projecting the remaining vertices to a spherical space in a coordinate system that describes the location of a point. The location of the point may be described in terms of radius, pan and tilt, or a combination of any of the three.

The method may include the step of storing the distance from the or each camera in three-dimensional space against each spherical coordinate.

The method may include the step of using the culled data to generate a bounding volume for each camera and to generate a depth map by projecting each point to spherical projection and generating a triangulation, giving a set of triangles which covers all points with no replication. The method may include the step of using the culled data to generate a bounding volume for each camera. The method may include the step of using the culled data to generate a depth map. The method may include the step of projecting each point to spherical projection. The method may include the step of generating triangulation, giving a set of triangles which cover all points with no replication.

The method may include the step of creating a triangle mesh from the spherical coordinates. The triangle mesh may be created using Delaunay triangulation.

The three-dimensional coordinates of the surface locations may be determined from a knowledge of the pan and tilt angles and the depth values. The distance between the points is calculated as the length of the vector that connects the two points.

The method may include the step of creating a depth map in terms of spherical coordinates.

The method may include the step of triangulating the depth map. The depth map may be triangulated by Delaunay triangulation.

The method may include the step of obtaining a distance between two selected points in the image by interpolation with triangulation.

The locations of the surface of the objects may comprise image pixels. The locations on the surface of the objects may comprise a single pixel.

The image, or each image, may be a 360° spherical image.

The method may include the step of determining a position of the or each camera in three-dimensional space. The method may include the step of generating spatial camera data.

The method may include the step of associating computer aided design (CAD) data with the spatial information.

The CAD data may be a design drawing, or the like.

The method may include the step of reducing, or culling, the CAD data. The step of reducing the CAD data may include discarding data which defines objects which are not visible from the given location. The step of discarding data which defines objects which are not visible from the given location may include analysis of pan and tilt angles and distance from the location.

The method may include the step of using the culled CAD data to generate a bounding volume, or bounding sphere. The spherical bounding of the CAD data may allow the CAD boundary to match the point cloud boundary.

The method may include the further step of associating data with one or more selected locations within the image. The method may include the further step of associating text or audio/visual files with one or more selected locations within the image. The data may be one or more of the group consisting of: text, audio, uniform resource locator (URL), equipment tags, or the like.

According to a second aspect of the present invention there is provided a system for recording spatial information, comprising:
a source of point cloud data for a given volume of space;
a source of one or more spherical images of the same volume of space, each image taken from a given location within that space;
a point cloud data reduction module, the point cloud data reduction module being operable to reduce the point cloud data to points which are visible from the given location or locations; and
a three-dimensional coordinate determination module, the three-dimensional coordinate determination module being operable to determine from the point cloud data the three-dimensional coordinates of each feature within the image or images.

Embodiments the second aspect of the present invention may include one or more features of the first aspect of the present invention or its embodiments.

According to a third aspect of the present invention there is provided a data processing and display system holding photographic, point cloud and computer aided design (CAD) data relating to a given volume of space, and in which the three forms of data are integrated together by sharing a common three-dimensional coordinate system.

Embodiments the third aspect of the present invention may include one or more features of the first, or second aspects of the present invention or their embodiments. Similarly, embodiments of the first or second aspects of the present invention may include one or more features of the third aspect or its embodiment.

According to a fourth aspect of the present invention there is provided a data carrier provided with program information for causing a computer to carry out the foregoing method.

Embodiments the fourth aspect of the present invention may include one or more features of the first, or second aspects of the present invention or their embodiments. Similarly, embodiments of the first, second or third aspects of the present invention may include one or more features of the fourth aspect or its embodiment.

### BRIEF DESCRIPTION OF THE DRAWINGS

Embodiments of the invention will now be described, by way of example, with reference to the drawings, in which:

FIG. 1 is a block diagram of one method and system embodying the present invention. FIG. 1 is a schematic illustration of a method for recording spatial information, a system for recording spatial information, and a data processing and display system holding photographic, point cloud and computer aided design (CAD) data relating to a given volume of space.

### DESCRIPTION OF PREFERRED EMBODIMENTS

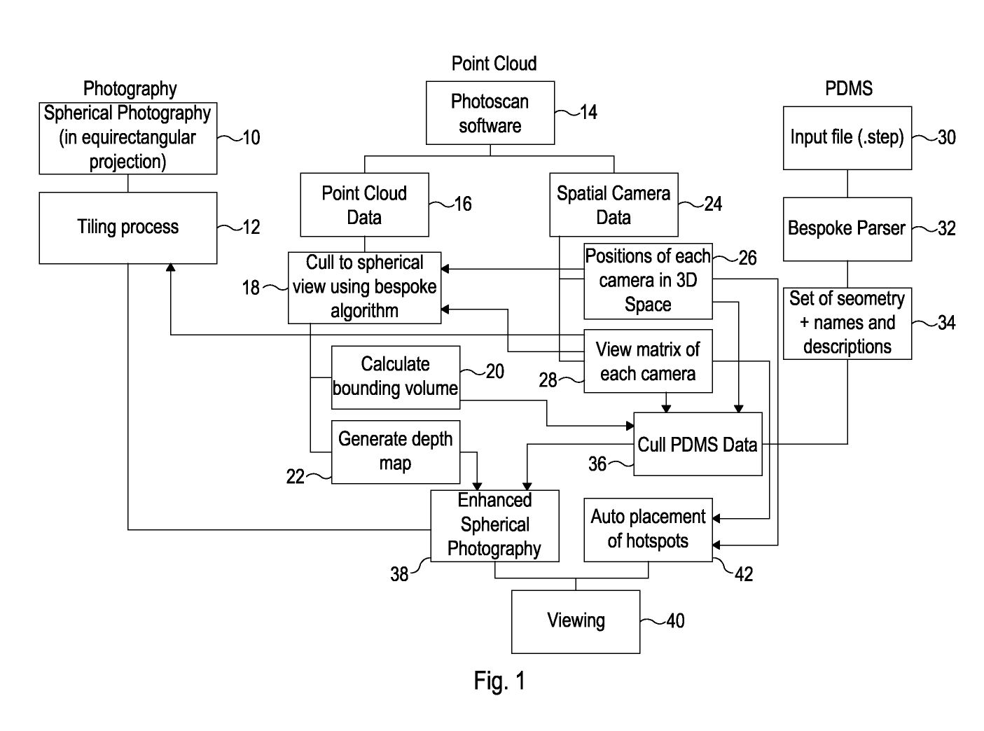

An overview of one method and system according to the present invention will first be described, followed by a more detailed description with reference to FIG. 1.

The following input data is acquired:
a. A point cloud file (from a laser scan, photogrammetry software, or other source) containing an unordered collection of vertices in 3D space which represents the area captured.
b. One or more spherical images of the area.
c. A set of camera positions and headings within the point cloud which describe the location of the images supplied in step b.

For each camera position, and thus each spherical image, the point cloud data is reduced using a technique referred to herein as “occlusion culling”, which removes points which are not visible from the camera position. One form of an occlusion culling algorithm operates as follows:
a. A number of “buckets” are created. For example, these may correspond to:
   1. The number of pixels in the spherical image (for example, an image of dimensions 12880×6440 would result in 82,947,200 buckets) or a multiple or sub-multiple thereof
   2. Portions of a degree of rotation in a sphere, e.g. every 0.5 degrees in both pan and tilt directions.
b. Each vertex in the source point cloud is evaluated and assigned to a bucket based on the horizontal and vertical angles between the vertex and the camera position.
c. If the assigned bucket already contains a vertex, the closest to the camera is retained and the further away is discarded.

The remaining vertices may be further culled to eliminate redundant data using techniques such as discarding every second (or third, fourth etc.) vertex (i.e. decimation); or plane detection—each vertex is compared to each of its immediate neighbours, if there is a significant difference in two or more dimensions the vertex is retained and if not it is discarded.

The vertices remaining after culling are projected to spherical space in a coordinate system which describes the location of a point in terms of radius, pan and tilt. The distance from the camera in three-dimensional (3D) space is also stored against each spherical coordinate.

A triangle mesh is then created from the spherical coordinates using Delaunay triangulation.

Having the information in this form allows a subsequent user to effect accurate measurements. The user highlights the points on the image that they wish to measure between. The triangles which contain these points in the depth map are identified. The three vertices of the triangle each have an associated depth value (from the above procedure). Interpolation between these three values gives the depth value at the point which the user clicked. The 3D coordinates of the selected points can be calculated from the pan and tilt angles and the depth values, and the distance between the points is calculated as the length of the vector that connects the two points. Typically, this allows the distance between any two points on the image to be calculated to an accuracy of a millimetre or less.

It will be appreciated that the foregoing is exemplary only. For example, it is convenient to use Delaunay triangulation as this is well understood. However, other methods of interpolating between acquired points may be used.

The significant process is to combine point cloud data with photographic data in a manner which greatly reduces the amount of data to be stored.

Referring now to FIG. 1, in this embodiment input is received from three sources, namely photography, point cloud data, and a 3D computer aided design (CAD) system such as plant design management system (PDMS). The third of these is optional and may be dispensed with in some applications.

The photography input is derived from one or more cameras in equiangular projection at 10 and then undergoes a tiling process 12. In the tiling process, the full size image is stored and a thumbnail image is made. The full size image is then tiled at a number of levels:
Level 0=1 tile to full size image
Level 1=4 tiles to full size image
Level 2=16 tiles to full size image
   and so on to the level desired. The purpose of tiling in this way is to allow images to be displayed at an appropriate level of detail as the image is zoomed in and out.

The point cloud source uses photoscan software 14 (or other suitable means) to produce point cloud data 16. The point cloud data is then culled at 18, as described above. This leaves a maximum of one point per pixel in the equirectangular image. The culled data is used to generate, at 20, a bounding volume for each camera, and to generate a depth map at 22 by projecting each point to spherical projection and generating a Delaunay triangulation, giving a set of triangles which covers all points with no replication.

The photoscan output is also used to generate spatial camera data at 24 which in turn generates a position of each camera in 3D space at 26 and a view matrix of each camera at 28, these being required inputs for the point data culling 18.

The CAD input uses an input file 30, typically the original design drawings, which is parsed at 32 to produce a set of geometry plus names and descriptions at 34.

The CAD data is then culled at 36 in a similar manner to the point cloud data. More specifically, the CAD data culling comprises:
spherical bounding (here the culled CAD data generates a CAD boundary (an example of a bounding volume, or bounding sphere). The spherical bounding of the CAD data allows the CAD boundary to match the point cloud boundary, as all references are from the camera location. The spheres are based on camera positions.
calculation of the volume of area contained.
checking each geometry item is contained within bounding volume.
projecting points of geometry item to camera space (camera in centre of spherical).
projecting points in camera space to 2D.
simplify resulting polygons to outlines.
projecting to spherical space. Projecting to two-dimensions (2D) allows for polygons which encompass an area with no distinct features within the polygon to be further simplified, which further reduces the data management requirement.

The process thus far provides enhanced spherical photography 38 which allows the user to view alternately photographic images and CAD images from any camera position and with any desired pan, tilt and zoom, but without the need for excessive amounts of data storage and processing, such that ordinary PCs, laptops and tablets can be used, and use on mobile devices such as smartphones is possible.

When viewing 40, photographic images are first presented at Level 0 and thereafter tiles are loaded based on spherical size, zoom and field of view level.

The method of this embodiment also allows for automatic placement of hotspots. “Hotspot” is used herein to refer to a specific item or location within the image, for example a valve or a gauge, which has a text or data file (such as a Word file, arbitrary text, a URL or an audio or video file) associated with it. In previous systems these were limited to one image and could not be shared between images since image locations were not defined by 3D coordinates in reference space. The present invention allows this to be done.

In the autoplacement step 42 of the present embodiment, a user can specify hotspots from either plans (CAD data) or from spherical photographs. In either case, a hotspot overlay is produced which combines the required display information and positional information. Thus the hotspots have positional information which can be shared throughout the system.

The invention thus allows both spherical photography and point cloud data to be combined. Essentially a depth map derived from a point cloud is used to add information to the photograph such that points in the photograph are defined in 3D coordinates, and can be linked to other systems using 3D coordinates with a common datum. Optionally, CAD information may be included which, for example, allows as-designed and as-built to be directly compared.

Modifications may be made to the foregoing embodiment within the scope of the present invention.

1. A method for recording spatial information, comprising:
forming a point cloud representing objects within a given volume of space;
obtaining at least one image from at least one given location within the given volume;
determining those points in the point cloud which are visible from the given location and discarding points in the point cloud which are not visible from the given location;
using the remaining point cloud data to determine the distance from the given location to locations on the surface of objects represented in the image; and
determining three dimensional coordinates of said surface locations.

2. The method of claim 1, wherein the point cloud includes points which are defined in three-dimensional space.

3. The method of claim 1, wherein the point cloud is point cloud data.

4. The method of claim 1, wherein the point cloud contains an unordered collection of vertices in three-dimensional space which represents at least a portion of the area/volume captured.

5. The method of claim 1, wherein the point cloud is formed from a laser scan, photogrammetry software, or the like.

6. The method of claim 1, wherein the step of obtaining at least one image from at least one given location within the given volume includes obtaining a photograph from one or more cameras in equiangular projection.

7. The method of claim 6, wherein the photograph undergoes a tiling process, the tiling process including tiling at a number of levels, each level containing an increasing number of tiles.

8. The method of claim 6, wherein the photograph is a spherical photograph.

9. The method of claim 1, wherein the step of obtaining at least one image from at least one given location within the given volume includes obtaining at least one set of camera positions within the point cloud which describe the location of the at least one image.

10. The method of claim 1, wherein the step of determining the points in the point cloud which are visible from the given location and discarding the points in the point cloud which are not visible from the given location includes the step of evaluating each vertex in the point cloud data on the basis of pan and tilt angles between the camera position and the vertex and, where two point cloud vertices share the same pan and tilt angles, discarding the one which is more distant from the camera position.

11. The method of claim 10, wherein the method includes the step of culling the vertices further.

12. The method of claim 10, wherein every n^{th} vertex is discarded.

13. The method of claim 10, wherein the step of culling the vertices further includes comparing adjacent vertices and discarding vertices if there is no significant difference in two or more dimensions.

14. The method of claim 10, wherein the number of vertices is reduced by plane detection.

15. The method of claim 11, wherein the method includes the step of associating computer aided design (CAD) data with the spatial information.

16. The method of claim 15, wherein the CAD data is reduced by discarding data defining objects which are not visible from the given location, by analysis of pan and tilt angles and distance from the location.

17. The method of claim 1, wherein the image, or each image, undergoes a tiling process, the tiling process including tiling at a number of levels, each level containing an increasing number of tiles.

18. The method of claim 1, wherein the method includes the step of creating a depth map in terms of spherical coordinates.

19. The method of claim 18, wherein the method includes the further step of triangulating the depth map.

20. The method of claim 19, wherein the method includes the step of obtaining a distance between two selected points in the image by interpolation with triangulation.

21. The method of claim 1, wherein the locations of the surface of the objects comprise image pixels, or a single image pixel.

22. The method of claim 1, wherein the image, or each image, is a 360° spherical image.

23. The method of claim 1, wherein the method includes the further step of associating data with one or more selected locations within the image, the data may be text or audio/visual files.

24. A system for recording spatial information, comprising:
a source of point cloud data for a given volume of space;
a source of one or more spherical images of the same volume of space, each image taken from a given location within that space;
a point cloud data reduction module, the point cloud data reduction module being operable to reduce the point cloud data to points which are visible from the given location or locations; and
a three-dimensional coordinate determination module, the three-dimensional coordinate determination module being operable to determine from the point cloud data the three-dimensional coordinates of each feature within the image or images.

25. A data processing and display system holding photographic, point cloud and computer aided design (CAD) data relating to a given volume of space, and in which the three forms of data are integrated together by sharing a common three-dimensional coordinate system.

26. A data carrier provided with program information for causing a computer to carry out a method comprising:
forming a point cloud representing objects within a given volume of space;
obtaining at least one image from at least one given location within the given volume;
determining those points in the point cloud which are visible from the given location and discarding points in the point cloud which are not visible from the given location;
using the remaining point cloud data to determine the distance from the given location to locations on the surface of objects represented in the image; and
determining three dimensional coordinates of said surface locations.
